(19) United States
(12) Patent Application Publication
(10) Pub. No.: US 2012/0116770 A1
(43) Pub. Date: May 10, 2012

(54) SPEECH DATA RETRIEVING AND PRESENTING DEVICE

(76) Inventors: Ming-Fu CHEN, Taipei (TW); Cheng-Hsiung Chen, Taipei (TW); Daow-Ming Jiang, Taipei (TW); Chan-Fa Chiu, Taipei (TW); Cheng-Jen Lin, Taipei (TW); Po-Yiu Liu, Taipei (TW)

(21) Appl. No.: 12/941,524

(22) Filed: Nov. 8, 2010

(51) Int. Cl. G10L 21/00; G06F 15/16

(52) U.S. Cl. 704/270; 709/217; 704/E21.001

(57) ABSTRACT

A speech data retrieving and presenting device applied with an electronic device through a network includes a data receiving unit, a processing unit and a speech presenting unit. The data receiving unit connected to the network receives data of the electronic device through the network. The processing unit coupled to the data receiving unit receives speech data and retrieves a speech presenting signal from the speech data. The speech presenting unit coupled to the processing unit receives the speech presenting signal and outputs a speech according to the speech data. This device can assist a user to obtain network information, and provide the user a more flexible application according to the property that the device can be operated independently by a simple motion.

### BACKGROUND OF THE INVENTION

1. Field of Invention

The invention relates to a speech data retrieving and presenting device, and more particularly to a speech data retrieving and presenting device for retrieving speech data from a network and presenting the speech data.

2. Related Art

The progress in the modern network technology gives the people more opportunities in obtaining information. In addition, the properties of the network are not restricted by the time and the distance, so that the flexibility and convenience of obtaining the information are further enhanced. In addition, various websites save and record rich data, and the people can obtain the information and knowledge, which can be obtained from the websites, have far exceeded those obtained by listening to the radio or watching the television.

However, not all persons can learn how to operate the device, or have time and energy for obtaining the interested information from the network world. For example, many jobholders may work in the environment, in which the computer cannot be conveniently accessed, or many seniors may be disinclined to use the computer. So, it is difficult for these jobholders or seniors to collect the useful information from the network, and the modern technology development seems to be incapable of enhancing their life quality or working efficiency.

The housewife is a most obvious example. Because there are many family affairs to be handled, the housewife is very busy. The concerned news may include how today's weather is, whether the weather is suitable for drying the clothes or blanket in the sun, whether the warehouse store has a discount, or even whether the value of the stock increases or decreases. The opportunity of obtaining the information may be missed because the user has no time or does not know how to operate the computer. In addition, the senior or the visually impaired person is often isolated from the network information because the data cannot be found unless many layers of clicking operations have to be performed, and most of the information over the network is stored as texts or pictures.

Therefore, it is an important subject of the invention to provide a speech data retrieving and presenting device capable of assisting the user to obtain the data from the network conveniently through the simple operation, and allowing the user, who cannot conveniently operate the computer or is not familiar with the computer, to retrieve and present the speech content immediately or at a specific time point through the schedule setting. In addition, many additional functions may be integrated on the basis of retrieving the speech information. Thus, the convenience and the fun of the user of enjoying the information life can be enhanced.

### SUMMARY OF THE INVENTION

In view of the foregoing, an objective of the invention is to provide a speech data retrieving and presenting device, which can assist the user to conveniently retrieve the interested information from the network and present the interested information. Most important of all, the device can be operated through a simple motion, and can retrieve and present the obtained speech content immediately or at the specific time instant, so that the user, who cannot conveniently operate the computer or is not familiar with the computer operation, can easily obtain the speech content.

In addition, the architecture of the device may serve as the platform for the storage and operation of the application software of retrieving the speech data, wherein the application programs with different uses may be downloaded through the network and installed to provide much more diversified additional functions to this device. Thus, the user can further obtain the information from a specific website or data source to enhance the convenience and fun of enjoying the information life. In addition, this device may also be improved on the hardware to become a modem having the speech data retrieving and presenting function.

Another objective of the invention is to provide a speech data retrieving and presenting device, which can receive speech data transmitted from a remote operator, such as the child working in other place, through the mobile phone or computer, and retrieve and present the speech data immediately or at the set specific time point to remind the senior or other family member and overcome the inconvenience caused by the distance.

Still another objective of the invention is to provide a speech data retrieving and presenting device, which can be applied with other devices having the same or similar functions to form a group network system. In addition, the users in the same group can immediately share the speech data through the setting of the classification function, so that the contact and the interpersonal relationship can be strengthened.

To achieve the above objectives, the invention discloses a speech data retrieving and presenting device applied with an electronic device through a network. The speech data retrieving and presenting device includes a data receiving unit, a processing unit and a speech presenting unit. The data receiving unit is connected to the network and receives data of the electronic device through the network. The processing unit is coupled to the data receiving unit for receiving the data and retrieving speech data from the data to obtain a speech presenting signal. The speech presenting unit is coupled to the processing unit for receiving the speech presenting signal and outputting a speech according to the speech data. Herein, the network is a wired network or a wireless network.

In one embodiment of the invention, the wireless network is a mobile communication system network, and the electronic device is a mobile phone.

In one embodiment of the invention, the data are a multimedia file, an E-mail, a multimedia short message or a combination thereof. Preferably, the content of the data includes a reminder, a task, a medicine taking time or a combination thereof.

In one embodiment of the invention, the wired network is Ethernet, and the electronic device is a computer or a server.

In one embodiment of the invention, the data are website content data, E-mail data or a combination thereof. Preferably, the data are website content data associated with weather information, life information, news information, stock market information, sport competition information, discount information, program schedule information, government propaganda data, health care information or a combination thereof.

In one embodiment of the invention, the speech data retrieving and presenting device further includes a timing unit coupled to the processing unit. Herein, the processing unit controls the timing unit to execute a timing event according to setup time data of the data, and then outputs the speech presenting signal to the speech presenting unit according to an executing condition of the timing event to control to output the speech.

In one embodiment of the invention, the speech data retrieving and presenting device further includes an information-receiving verification unit coupled to the processing unit. The processing unit receives an information-receiving verification signal through the information-receiving verification unit. Herein, the processing unit stops the speech presenting unit from outputting the speech according to the information-receiving verification signal. Preferably, the speech data retrieving and presenting device further includes a signal transmission unit connected to the network and coupled to the processing unit. The processing unit controls the signal transmission unit to transmit a return signal or return data to the electronic device through the network according to the information-receiving verification signal.

In one embodiment of the invention, the speech data retrieving and presenting device further includes a storage unit coupled to the data receiving unit and the processing unit. The data receiving unit receives at least one set of application program data and stores the set of application program data to the storage unit, and the processing unit executes a corresponding function according to the application program data. Herein, the function includes outputting the speech, listening to a radio, presenting music or timekeeping.

In one embodiment of the invention, the speech data retrieving and presenting device further includes an operation interface coupled to the processing unit and having at least one operation element. The processing unit receives a switching event through the operation element to obtain a switching signal, and switches between a function of outputting the speech and a function corresponding to the application program data according to the switching signal. Preferably, the operation element is a physical key, a physical knob or a touch screen.

In one embodiment of the invention, the speech data retrieving and presenting device further includes a group setting unit and a signal transmission unit. The group setting unit is coupled to the processing unit, and the processing unit judges a group to which the data pertain according to group classification information stored in the group setting unit. The signal transmission unit is connected to the network and coupled to the processing unit. Herein, the processing unit controls the signal transmission unit to transmit the data to another speech data retrieving and presenting device in the same group through the network according to the group classification information.

In one embodiment of the invention, the speech data retrieving and presenting device further includes a statistical unit coupled to the processing unit. The processing unit receives return data, outputted from another speech data retrieving and presenting device, through the data receiving unit, and controls the statistical unit to classify and compile the return data to obtain a corresponding statistical result.

To achieve the above objectives, the invention also discloses a modem, connected to a network, for retrieving and presenting speech data. The modem includes a network interface, a processing unit and a speech presenting unit. The network interface connected to the network for receiving data through the network. The processing unit is coupled to the network interface for receiving the data and retrieving the speech data from the data to obtain a speech presenting signal. The speech presenting unit is coupled to the processing unit for receiving the speech presenting signal and outputting a speech according to the speech data. Herein, the received data are website content data, E-mail data or a combination thereof. Preferably, the data are website content data associated with weather information, life information, news information, stock market information, sport competition information, discount information, program schedule information, government propaganda data, health care information or a combination thereof.

As mentioned above, the speech data retrieving and presenting device according to the invention utilizes the data receiving unit to receive the data of the electronic device on the other end of the network, and then utilizes the processing unit to distinguish and further retrieve the speech data therefrom according to the program setting. Thus, the speech data can be outputted to the user through the speech presenting unit to achieve the object of assisting the user to listen or understand the network speech data. Most important of all, the above-mentioned operation mechanisms allow the user to activate the device through the single motion under the architecture of the invention, so that the trouble of operating the computer and its complicated executed program can be avoided. For the housewife or the housekeeper, the threshold of obtaining the information is decreased, and the housewife or the housekeeper can concurrently perform multiple works to effectively enhance the working efficiency.

The processing unit can directly retrieve the data associated with the reminder and the timing data through the speech data recognition. So, the children working in other places can conveniently retrieve and present the speech immediately or at the specific time instant, and remind the parents to take the medicines on time using the mobile phone multimedia short message or E-mail as the medium. Thus, the distances between the children and the parents can be shortened, and the cares can be provided timely.

Furthermore, the speech data retrieving and presenting device of the invention has the good flexible application, and is adapted to the platform for the storage and operation of the speech data application software. In addition, the hardware can be improved to become the modem with the speech data retrieving and presenting function. In addition, the device may also be applied with the other same or similar devices to form a group network system. According to the group setting, the speech information can be transmitted to the users in the same group, so that the users in the same group can share the speech information in time.

Compared with the prior art, the invention allows the user, who is not familiar with the computer operation or has no time to operate the computer, to quickly obtain the required network information, and integrate various sources of information through the stored or downloaded application program to facilitate the user's life. In addition, the invention may also be applied to the group of users having the common interest, so that the speech information over the network can be effectively shared between the associated members without manual operations. In addition, the members of the group can be flexibly adjusted through the return and statistical mechanisms, and the utility of the information can be ensured.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematically perspective view showing a speech data retrieving and presenting device according to a first preferred embodiment of the invention;

FIG. 2 is a system block diagram showing the speech data retrieving and presenting device of FIG. 1;

FIG. 3 is a schematic illustration showing the speech data retrieving and presenting device of FIG. 1 applied with a network and an electronic device;

FIGS. 4 to 6 are system block diagrams showing speech data retrieving and presenting devices according to various embodiments of the invention;

FIG. 7 is a schematically enlarged view showing an operation interface of the speech data retrieving and presenting device of FIG. 6;

FIG. 8 is a system block diagram showing the speech data retrieving and presenting device of FIG. 6; and

FIG. 9 is a system block diagram showing a speech data retrieving and presenting device according to a sixth preferred embodiment of the invention.

### DETAILED DESCRIPTION OF THE INVENTION

The present invention will be apparent from the following detailed description, which proceeds with reference to the accompanying drawings, wherein the same references relate to the same elements.

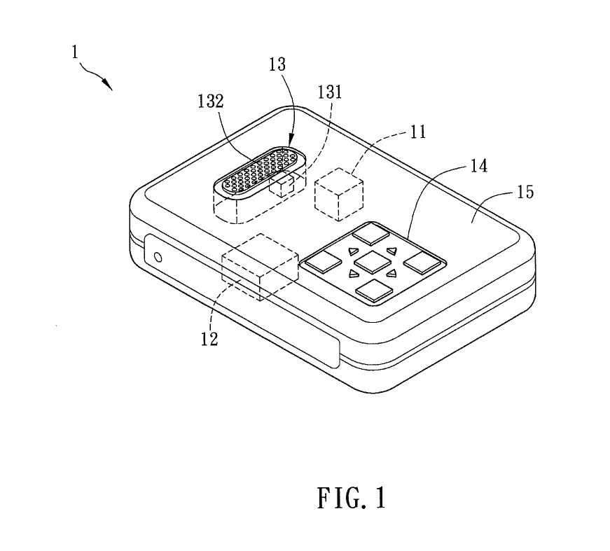

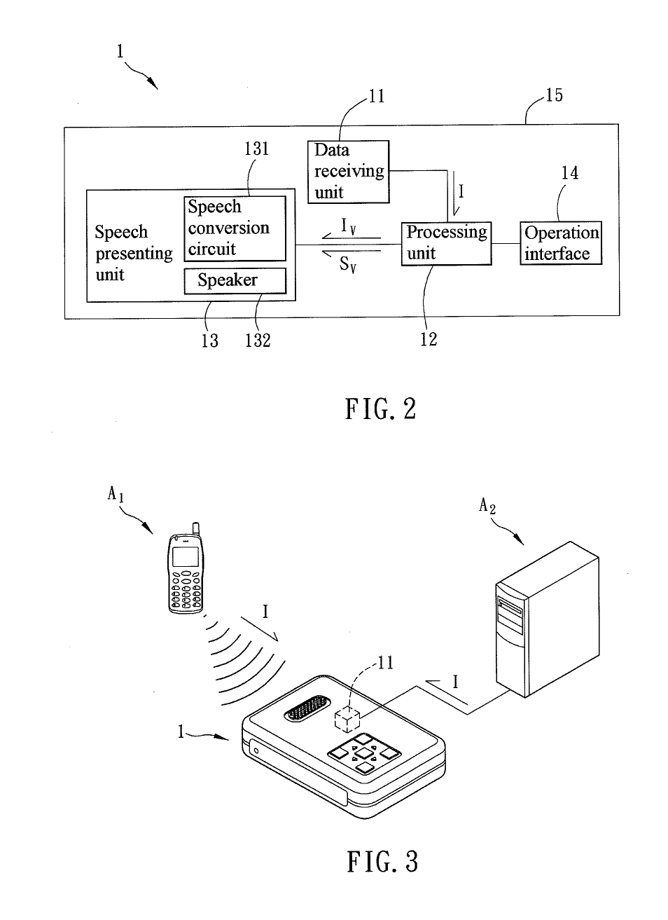

FIG. 1 is a schematically perspective view showing a speech data retrieving and presenting device 1 according to a first preferred embodiment of the invention. FIG. 2 is a system block diagram showing the speech data retrieving and presenting device 1 of FIG. 1. Referring to FIG. 1, the speech data retrieving and presenting device 1 of this embodiment includes a data receiving unit 11, a processing unit 12, a speech presenting unit 13, an operation interface 14 and a housing 15. The data receiving unit 11, the processing unit 12 and the speech presenting unit 13 are disposed within the housing 15, but a portion of the speech presenting unit 13 and the operation interface 14 are exposed out of the surface of the housing 15 so as to output a speech truly for the user's operation. The data receiving unit 11 may be a network interface circuit connected to the network, such that the speech data retrieving and presenting device 1 obtains or receives data from the network. The processing unit 12 may be a central processing unit (CPU) or a microprocessor for mainly processing the inputted data and thus obtaining and outputting corresponding data or signals. The speech presenting unit may include, for example, a speech conversion circuit 131 and a speaker 132. The speech conversion circuit 131 converts the received digital speech data into analog speech data, and then the speaker 132 outputs the speech corresponding to the analog speech data. The operation interface 14 may have a plurality of buttons respectively corresponding to various predefined values or functions to be used for the user's manual operations.

Referring to FIG. 2 of this embodiment, the data receiving unit 11 and the speech presenting unit 13 are respectively coupled to the processing unit 12. In detail, the data receiving unit 11 and the speech presenting unit 13 are electrically connected to the processing unit 12 so that the signal or data can be transmitted thereamong.

FIG. 3 is a schematic illustration showing the speech data retrieving and presenting device of FIG. 1 applied with a network and an electronic device. Referring to FIGS. 2 and 3, the data receiving unit 11 of the invention can be connected to the network, so that the speech data retrieving and presenting device 1 can receive data I of the electronic device(s) A₁ and/or A₂ respectively or simultaneously through the network. As mentioned hereinabove, the data receiving unit 11 is the network interface circuit in this embodiment, wherein the so-called network interface circuit includes, without limitation to, the wired and/or wireless network interface circuit(s), and the network applied therewith may include the wireless network and/or the wired network. In this embodiment, the data receiving unit 11 is preferably the Ethernet interface, while the wired network is the Ethernet, and the electronic device A₂ is the computer or server, in which the data I are stored. The technological contents and characteristics of the invention will be further described with reference to this embodiment.

As shown in FIGS. 2 and 3, the data receiving unit 11 in this embodiment is connected to the Ethernet, such that the speech data retrieving and presenting device 1 can receive the data I, provided by the electronic device A₂, through the Ethernet. The types of the data I are not particularly restricted, and may include, for example, the website content data, the E-mail data or a combination thereof However, at least a portion of the data I is the speech data. Regarding to its content, the data I are preferably the website content data associated with the weather information, life information, news information, stock market information, sport competition information, discount information, program schedule information, government propaganda data, health care information or a combination thereof. The method of providing the data I is not particularly restricted. The data may be actively outputted from the electronic device A₂. Alternatively, the user may firstly manually operate the operation interface 14 to control the speech data retrieving and presenting device 1 to output a request to the electronic device A₂, and then the data I may be obtained.

The data receiving unit 11 receives the data I and transmits the data I to the processing unit 12, and the processing unit 12 receives and then analyzes the data I, and retrieves speech data I_{V} from the data I. The retrieved speech data I_{V} may be, for example, a portion or a whole of the speech data with the digital format in the data I, and are determined after the judgment or comparison is made according to the settings of the processing unit 12, or determined according to the control data therein after the processing unit 12 reads the built-in database (not shown) of the speech data retrieving and presenting device 1. After completely retrieving the speech data I_{V}, the processing unit 12 can obtain a speech presenting signal S_{V}, and outputs the speech presenting signal S_{V}, together with the speech data I_{V}, to the speech presenting unit 13. After the speech presenting unit 13 receives the speech presenting signal S_{V}, its speech conversion circuit 131 can convert the speech data I_{V} from the digital format into the analog format, and then the speaker 132 outputs a speech.

According to the above-mentioned principle, the operations of the speech data retrieving and presenting device 1 of the invention will be described in detail according to an actual application. The drawings according to the above-mentioned embodiment will also be referred. First, a user, such as a housewife, connects a network cable to the data receiving unit 11, such that the speech data retrieving and presenting device 1 can be connected to the Ethernet through the internal software and hardware settings.

When the user wants to know today's weather forecast content, he or she only has to press the corresponding button on the operation interface 14 to input an event to the processing unit 12 through the operation interface 14. Thereafter, the processing unit 12 controls the data receiving unit 11 to go to the website of the Central Weather Bureau (associated content is stored in the electronic device A₂) to search and receive the data I according to the built-in predefined value. The data I associated with today's weather forecast content are represented by the integrated texts, images and speech, which may be combined as a multimedia file or a data folder. After the data receiving unit 11 receives and transmits the data I to the processing unit 12, the processing unit 12 can judge and retrieve the digital format speech data I_{V} (e.g., today's weather speech broadcast content) from the data I. After retrieving the speech data I_{V}, the processing unit 12 outputs the speech presenting signal S_{V} to the speech presenting unit 13. After receiving the speech data I_{V}, the speech presenting unit 13 may adopt the speech conversion circuit 131 to convert the digital format speech data I_{V} into the analog format speech data, and finally controls, according to the speech presenting signal S_{V}, the speaker 132 to output the speech according to the speech data I_{V} and thus to provide today's weather forecast content to the user.

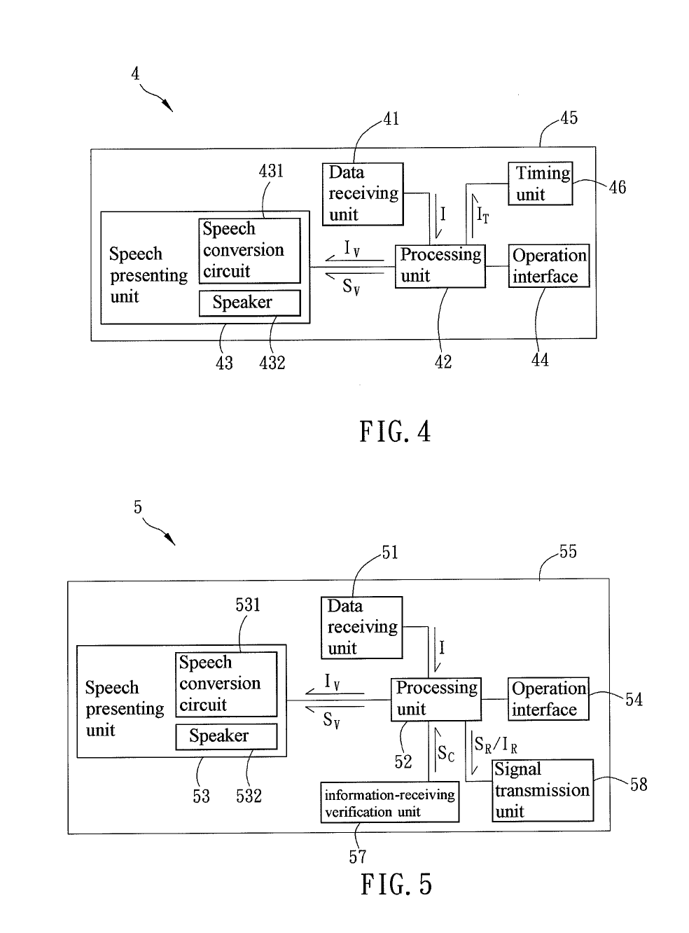

FIG. 4 is a system block diagram showing a speech data retrieving and presenting device 4 according to a second preferred embodiment of the invention. As shown in reference FIG. 4, the speech data retrieving and presenting device 4 of this embodiment is built based on the element structure of the first embodiment, and further includes a timing unit 46 accommodated with a housing 45 and electrically connected to a processing unit 42. The processing unit 42 can receive a timing setting event through an operation interface 44, or judge the setup time data from the data I, and output timing data I_{T} to the timing unit 46 to control the timing unit 46 to compare the existing time data according to the timing data I_{T} and execute a timing event. Thereafter, the processing unit 42 outputs the speech presenting signal S_{V} to a speech presenting unit 43 to control the output of the speech at the set time point according to the executing condition of the timing event.

For example, the processing unit 42 judges the content of the timing data I_{T} as presenting the speech at 10 o'clock in tomorrow morning, and then judges to output the speech after 12 hours according to the current time of the timing unit 46, and starts to count the time to truly retrieve and present the speech content after 12 hours. The so-called “executing condition” is not restricted to calculating elapses or how much time is left. In other words, the invention is not restricted to the time countup or time countdown. The content thereof is provided for the main purpose of judging whether the predetermined time is reached, and the used method is not particularly restricted. The timing content may include the time in one day, one week or one to several months, and is determined according to the inputted setup time data. Of course, the above-mentioned timing data I_{T} may be in any form, such as texts or speeches.

In a third preferred embodiment of the invention, the speech data retrieving and presenting device is almost the same as the first embodiment. However, its data receiving unit is a mobile communication system network receiver, while the network and the electronic device are respectively a mobile communication system network and a mobile phone. During the operation, the remote data provider may utilize the mobile phone to transmit data to the speech data retrieving and presenting device, wherein the transmitted data may be, for example, a multimedia file, an E-mail, a multimedia short message or a combination thereof. Of course, at least one portion of the data content is the speech data. Thereafter, the processing unit can retrieve the portion of the speech data from the data according to the same operation principle, and control the speech presenting unit to output the speech immediately or timely. In the actual application, the speech data retrieving and presenting device of this embodiment may be used by the children working in other places, and their elder parents, wherein the children can use their mobile phones to simply transmit the multimedia short messages or E-mails to the house of the older parents, and then output the speech, containing the reminder, task, medicine taking time or a combination thereof, immediately or at a specific time through the automatic retrieving of the speech data to achieve the object of caring the seniors. Meanwhile, the seniors do not have to worry about the trouble in operating the computer.

Consequently, the speech data retrieving and presenting device of the invention can assist the user to conveniently retrieve and present the interested information from the network, or can facilitate the children, working in other places, in reminding the older parents to take the medicines on time. In addition, the device of the invention can be operated through a simple motion (e.g., pressing the key on the operation interface), and may be applied with the mobile phone to eliminate the inconvenience that the user has to rely on the computer.

FIG. 5 is a system block diagram showing a speech data retrieving and presenting device 5 according to a fourth preferred embodiment of the invention. Referring to FIG. 5, the element structure of the speech data retrieving and presenting device 5 of this embodiment is almost the same as that of FIG. 1 except that the speech data retrieving and presenting device 5 further includes an information-receiving verification unit 57. In this embodiment, the information-receiving verification unit 57 may be a button or a switch, which is disposed on a housing 55 and to be operated by the user to stop the speech data retrieving and presenting device 5 from continuously outputting the speech after the required information is indeed received. Of course, the information-receiving verification unit 57 may also be a button on an operation interface 54, and the invention is not particularly restricted thereto. Regarding the connection relationship and the signal transmission, the information-receiving verification unit 57 is coupled to a processing unit 52. After the user presses the information-receiving verification unit 57, the processing unit 52 receives an information-receiving verification signal S_{C} through the information-receiving verification unit 57. Thereafter, the processing unit 52 further stops a speech presenting unit 53 from outputting the speech according to the information-receiving verification signal S_{C} to prevent, for example, the housewife from repeatedly listening to the same weather forecast data.

Referring again to FIG. 5, the speech data retrieving and presenting device 5 of this embodiment further includes a signal transmission unit 58, which is the same as a data receiving unit 51 and may be the network interface circuit. In the embodiment of FIG. 5, the signal transmission unit 58 and the data receiving unit 51 are separately arranged, and are independently connected to the network and coupled to the processing unit 52. In other aspects of the embodiment, however, the signal transmission unit 58 may also be integrated with the data receiving unit 51 to form a network connection module, and the invention is not particularly restricted. In addition, the network to which the signal transmission unit 58 may be connected is not particularly restricted to the wired or wireless network. After the processing unit 52 receives the information-receiving verification signal S_{C}, it can control the signal transmission unit 58 to transmit a return signal S_{R} or return data I_{R} to the electronic device through the network, and to inform the holder of the electronic device about that the user has indeed received the message or data. The application function is particularly suitable for the senior to automatically complete the return through the simple motion after the senior has received the speech of the child reminding the senior to take the medicines.

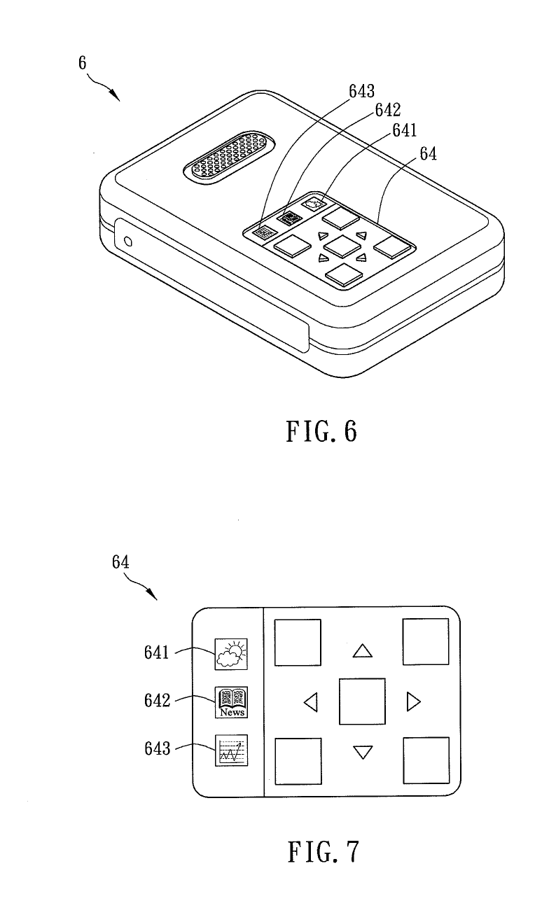

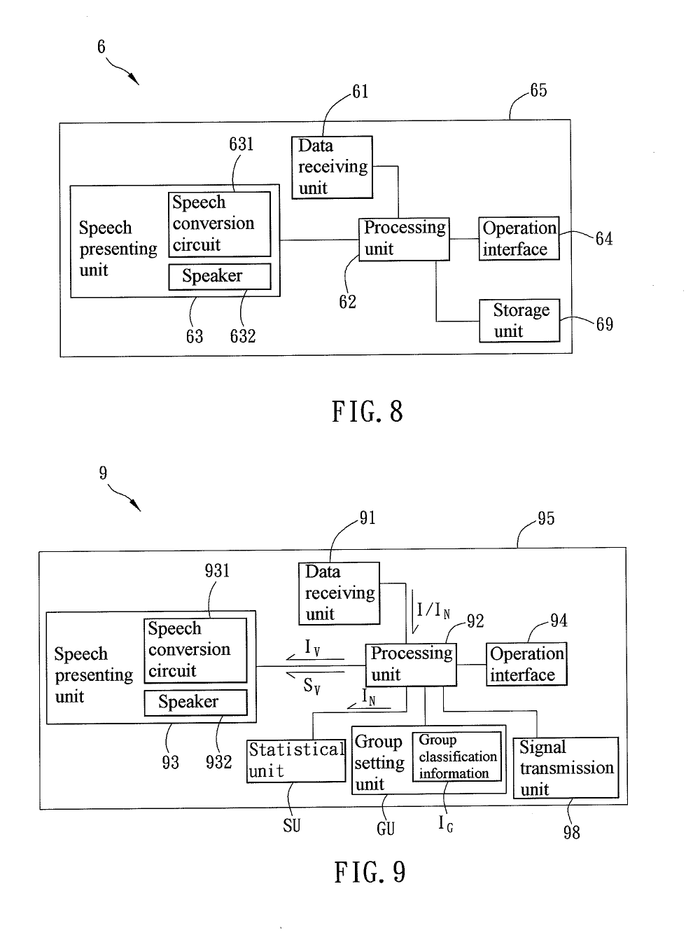

FIG. 6 is a stereoscopic perspective view showing a speech data retrieving and presenting device 6 according to a fifth preferred embodiment of the invention. FIG. 7 is a schematically enlarged view showing an operation interface of the speech data retrieving and presenting device 6 of FIG. 6. FIG. 8 is a system block diagram showing the speech data retrieving and presenting device 6 of FIG. 6. Referring to FIGS. 6 to 8, the speech data retrieving and presenting device 6 of this embodiment is built based on the element structure of the first embodiment and further includes a storage unit 69, wherein an operation interface 64 has at least one of operation elements 641 to 643. In this embodiment, the storage unit 69 is accommodated within a housing 65 and coupled to a data receiving unit 61 and a processing unit 62. The operation interface 64 has three operation elements 641 to 643, which are respectively independent physical keys projecting beyond the housing 65 and the operation interface 64. Of course, the operation elements 641 to 643 may also be a physical knob or a touch screen according to the design requirement, and the invention is not particularly restricted thereto.

After the data receiving unit 61 passively obtains or actively downloads at least one set of application program data through the network, it can store the application program data to the storage unit 69. After a specific event (e.g., a specific application function is enabled) is received, the processing unit 62 can execute a corresponding function, which includes outputting the speech, listening to the radio, presenting music or timekeeping, according to the application program data. In one example, the real-time news speech data, provided by the website of the network station, may be obtained and then the news content is outputted to the user.

The application program may be one of widgets, which is, for example, an application program with the small file size and may be applied with other software/hardware to instruct the speech data retrieving and presenting device 6 to download, from a specific website, a program with the data interested by the user, or any program of transmitting data containing the speech content. Thus, the speech data retrieving and presenting device 6 of this embodiment may serve as a platform for the operation of the application program associated with the network speech to enhance the flexible application of the speech data retrieving and presenting device 6.

FIG. 9 is a system block diagram showing a speech data retrieving and presenting device 9 according to a sixth preferred embodiment of the invention. As shown in FIG. 9, the speech data retrieving and presenting device 9 of this embodiment is built based on the element structure of the first embodiment and further includes a group setting unit GU, a statistical unit SU and a signal transmission unit 98. The so-called group mainly represents the users having the same hobby or being interested on the same topic. The users are grouped into the same list, which are stored in the device, through the manual setting or the automatic setting of the device. Most important of all, the list may contain the corresponding network positions of the users so that a processing unit 92 can work according to the network positions. Of course, the members of the group can be momentarily and dynamically adjusted based on, for example, the frequency and times of retrieving the associated data, or the return conditions after the data are shared (the detailed content will be further described in the following).

The group setting unit GU is accommodated within a housing 95 and coupled to the processing unit 92. So, when the data I are received, the processing unit 92 compares the contents of the data I according to the group classification information I_{G} (containing the above-mentioned group list) set in the group setting unit GU, judges which group they pertains, and further instructs the signal transmission unit 98 to transmit, through the network, the data I to the another speech data retrieving and presenting device or other electronic devices in the same group. Thus, the object of sharing the speech data in the same group can be achieved.

In this embodiment, after the data I are transmitted to the another speech data retrieving and presenting device or other electronic devices in the same group, the speech data retrieving and presenting device 9 can further receive the return data I_{N} returned therefrom. For example, the contents of the return data I_{N} may include whether the data I are received, the response to the data I (e.g., approval or disapproval) and whether the user wishes to receive the associated data again. The return data I_{N} may be received by a data receiving unit 91 and transmitted to the processing unit 92, which controls the statistical unit SU to collect, classify and compile multiple sets of return data I_{N} to obtain a corresponding statistical result serving as the basis for the future group classification.

The invention additionally discloses a modem having the speech data retrieving and presenting function. The modem is connected to a network and includes a network interface, a processing unit and a speech presenting unit. However, the technological characteristic and element architecture of this modem are similar to those of the speech data retrieving and presenting device 1 according to the first embodiment of the invention (see FIGS. 1 and 2). The network interface of the modem is also equivalent to the data receiving unit 11 connected to the Ethernet, but additionally has the function of the modem. It is to be specified that, compared with the prior art modem, the modem of the invention may be utilized to receive the website content data, E-mail data or a combination thereof, and further retrieve and output the speech data thereof. In practice, the modem may be operated by the user through the simple motion to retrieve and present, by way of speech, the website content data associated with the weather information, life information, news information, stock market information, sport competition information, discount information, program schedule information, government propaganda data, health care information or a combination thereof. Thus, the network function may be further integrated to effectively facilitate the user's life.

To sum up, the speech data retrieving and presenting device according to the invention utilizes the data receiving unit to receive the data of the electronic device on the other end of the network, and then utilizes the processing unit to distinguish and further retrieve the speech data therefrom according to the program setting. Thus, the speech data can be outputted to the user through the speech presenting unit to achieve the object of assisting the user to listen or understand the network speech data. Most important of all, the above-mentioned operation mechanisms allow the user to activate the device through the single motion under the architecture of the invention, so that the trouble of operating the computer and its complicated executed program can be avoided. For the housewife or the housekeeper, the threshold of obtaining the information is decreased, and the housewife or the housekeeper can concurrently perform multiple works to effectively enhance the working efficiency.

The processing unit can directly retrieve the data associated with the reminder and the timing data through the speech data recognition. So, the children working in other places can conveniently retrieve and present the speech immediately or at the specific time instant, and remind the parents to take the medicines on time using the mobile phone multimedia short message or E-mail as the medium. Thus, the distances between the children and the parents can be shortened, and the cares can be provided timely.

Furthermore, the speech data retrieving and presenting device of the invention has the good flexible application, and is adapted to the platform for the storage and operation of the speech data application software. In addition, the hardware can be improved to become the modem with the speech data retrieving and presenting function. In addition, the device may also be applied with the other same or similar devices to form a group network system. According to the group setting, the speech information can be transmitted to the users in the same group, so that the users in the same group can share the speech information in time.

Compared with the prior art, the invention allows the user, who is not familiar with the computer operation or has no time to operate the computer, to quickly obtain the required network information, and integrate various sources of information through the stored or downloaded application program to facilitate the user's life. In addition, the invention may also be applied to the group of users having the common interest, so that the speech information over the network can be effectively shared between the associated members without manual operations. In addition, the members of the group can be flexibly adjusted through the return and statistical mechanisms, and the utility of the information can be ensured.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A speech data retrieving and presenting device applied with an electronic device through a network, the speech data retrieving and presenting device comprising:
a data receiving unit, connected to the network, for receiving data of the electronic device through the network;
a processing unit, coupled to the data receiving unit, for receiving the data and retrieving speech data from the data to obtain a speech presenting signal; and
a speech presenting unit, coupled to the processing unit, for receiving the speech presenting signal and outputting a speech according to the speech data.

2. The speech data retrieving and presenting device according to claim 1, wherein the network is a wired network or a wireless network.

3. The speech data retrieving and presenting device according to claim 2, wherein the wireless network is a mobile communication system network, and the electronic device is a mobile phone.

4. The speech data retrieving and presenting device according to claim 3, wherein the data are a multimedia file, an E-mail, a multimedia short message or a combination thereof.

5. The speech data retrieving and presenting device according to claim 3, wherein a content of the data comprises a reminder, a task, a medicine taking time or a combination thereof.

6. The speech data retrieving and presenting device according to claim 2, wherein the wired network is Ethernet, and the electronic device is a computer or a server.

7. The speech data retrieving and presenting device according to claim 1, wherein the data are website content data, E-mail data or a combination thereof.

8. The speech data retrieving and presenting device according to claim 6, wherein the data are website content data associated with weather information, life information, news information, stock market information, sport competition information, discount information, program schedule information, government propaganda data, health care information or a combination thereof.

9. The speech data retrieving and presenting device according to claim 1, further comprising:
a timing unit coupled to the processing unit, wherein the processing unit controls the timing unit to execute a timing event according to setup time data of the data, and then outputs the speech presenting signal to the speech presenting unit according to an executing condition of the timing event to control to output the speech.

10. The speech data retrieving and presenting device according to claim 1, further comprising:
an information-receiving verification unit coupled to the processing unit, which receives an information-receiving verification signal through the information-receiving verification unit.

11. The speech data retrieving and presenting device according to claim 10, wherein the processing unit stops the speech presenting unit from outputting the speech according to the information-receiving verification signal.

12. The speech data retrieving and presenting device according to claim 10, further comprising:
a signal transmission unit connected to the network and coupled to the processing unit, wherein the processing unit controls the signal transmission unit to transmit a return signal or return data to the electronic device through the network according to the information-receiving verification signal.

13. The speech data retrieving and presenting device according to claim 1, further comprising:
a storage unit coupled to the data receiving unit and the processing unit, wherein the data receiving unit receives at least one set of application program data and stores the at least one set of application program data to the storage unit, and the processing unit executes a corresponding function according to the application program data.

14. The speech data retrieving and presenting device according to claim 13, wherein the function comprises outputting the speech, listening to a radio, presenting music or timekeeping.

15. The speech data retrieving and presenting device according to claim 14, further comprising:
an operation interface coupled to the processing unit and having at least one operation element, wherein the processing unit receives a switching event through the operation element to obtain a switching signal, and switches between a function of outputting the speech and a function corresponding to the application program data according to the switching signal.

16. The speech data retrieving and presenting device according to claim 14, wherein the operation element is a physical key, a physical knob or a touch screen.

17. The speech data retrieving and presenting device according to claim 1, further comprising:
a group setting unit coupled to the processing unit, which judges a group to which the data pertain according to group classification information stored in the group setting unit; and
a signal transmission unit connected to the network and coupled to the processing unit, wherein the processing unit controls the signal transmission unit to transmit the data to another speech data retrieving and presenting device in the same group through the network according to the group classification information.

18. The speech data retrieving and presenting device according to claim 17, further comprising:
a statistical unit coupled to the processing unit, wherein the processing unit receives return data, outputted from the another speech data retrieving and presenting device, through the data receiving unit, and controls the statistical unit to classify and compile the return data to obtain a corresponding statistical result.

19. A modem, connected to a network, for retrieving and presenting speech data, the modem comprising:
a network interface connected to the network, for receiving data through the network;
a processing unit, coupled to the network interface, for receiving the data and retrieving the speech data from the data to obtain a speech presenting signal;
and
a speech presenting unit, coupled to the processing unit, for receiving the speech presenting signal and outputting a speech according to the speech data.

20. The modem according to claim 19, wherein the data are website content data, E-mail data or a combination thereof.

21. The modem according to claim 20, wherein the data are website content data associated with weather information, life information, news information, stock market information, sport competition information, discount information, program schedule information, government propaganda data, health care information or a combination thereof.
